(19) United States
(12) Patent Application Publication
(10) Pub. No.: US 2003/0036330 A1
(43) Pub. Date: Feb. 20, 2003

(54) Method of manufacturing a display device

(76) Inventors: Hans Galenkamp, Eindhoven (NL); Bruno J. Spolders, Eindhoven (NL)

Correspondence Address: Corporate Patent Counsel, U.S. Philips Corporation, 580 White Plains Road, Tarrytown, NY, 10591, US

(21) Appl. No.: 10/200,951

(22) Filed: Jul. 22, 2002

Related U.S. Application Data
(63) Continuation-in-part of application No. 09/168,455, filed on Oct. 8, 1998, now Pat. No. 6,422,744.

(30) Foreign Application Priority Data
Oct. 8, 1997 (EP) 97203125.6

(51) Int. Cl. H01J 9/00

(52) U.S. Cl. 445/3

(57) ABSTRACT

A method of manufacturing a display device having an air-tight envelope, in which a glass face plate and at least one further glass part are joined to form the air-tight envelope that is to be heated and/or evacuated at a later stage of the method of manufacture, comprises inducing a thermoshock in the face plate and/or the at least one further glass part prior to joining the glass face plate and the at least one further glass part to form the air-tight envelope; examining the face plate and/or the at least one further glass part for growth of cracks indicative of defects which could render the air-tight envelope liable to implosion during heating and/or evacuation; choosing between selecting and non-selecting the face plate and/or the at least one further glass part for use as part of the air-tight envelope depending on whether the growth of cracks has been found; using the face plate and the at least one further glass part as part of the air-tight envelope if the growth of cracks was not found; and performing the heating and/or evacuation of the air-tight envelope after the air-tight envelope has been constructed using the face plate and the at least one further glass part.

### FIELD OF TECHNOLOGY

The invention relates to display devices, and more particularly to a method of manufacturing a display device comprising an air-tight envelope, in which a glass face plate and at least one further glass part are joined to form the air-tight envelope, with the envelope being heated and evacuated at a later stage.

### BACKGROUND AND SUMMARY

Display devices of the type mentioned in the above paragraph are used, inter alia, in television receivers and computer monitors. An example device of this type has an air-tight envelope with a display window. In the case of a cathode ray tube (CRT), the envelope also comprises a cone portion and a neck which accommodates an electron gun for generating (one or more) electron beams. These electron beams are focused on a phosphor layer on the inner surface of the display window. In the case of a plasma display panel (PDD), the air-tight envelope comprises a faceplate, which serves as the display window, and a rear plate, the plates being connected to each other by means of connecting parts. A plasma display panel contains an ionizable gas in which a plasma discharge is generated, and electroluminescent or photo-luminescent phosphors being used to produce an image.

These devices have a number of shortcomings, in particular the occurrence of product failure during the manufacture of the display device, which product failure is caused by fracture as a result of, for example, implosion of the display device during the evacuation of the envelope. It would be advantageous to provide a method of selecting the glass parts in an early stage of the manufacturing process of the display device, so that the risk that the above-mentioned problem occurs is reduced.

To achieve this, the invention comprises a method of manufacturing a display device having an air-tight envelope, in which a glass face plate and at least one further glass part are joined to form the air-tight envelope that is to be heated and/or evacuated at a later stage of the method of manufacture, comprising inducing a thermoshock in the face plate and/or the at least one further glass part prior to joining the glass face plate and the at least one further glass part to form the airtight envelope; examining the face plate and/or the at least one further glass part for growth of cracks indicative of defects which could render the air-tight envelope liable to implosion during heating and/or evacuation; choosing between selecting and non-selecting the face plate and/or the at least one further glass part for use as part of the air-tight envelope depending on whether the growth of cracks has been found; using the face plate and the at least one further glass part as part of the air-tight envelope if the growth of cracks was not found; and performing the heating and/or evacuation of the air-tight envelope after the air-tight envelope has been constructed using the face plate and the at least one further glass part.

This and other aspects of the invention will be apparent from and elucidated with reference to the embodiments described hereinafter.

### BRIEF DESCRIPTION OF THE DRAWING FIGURES

The invention can be understood with reference to the following drawing figures, in which:

FIG. 1A is a cut-away view of a display device comprising a cathode ray tube;

FIG. 1B is a cross-sectional view of a display window of the display device shown in FIG. 1A, and

FIGS. 2A and 2B schematically show an example of the method in accordance with the invention.

The figures are purely schematic and not drawn to scale. Particularly for clarity, some dimensions are exaggerated strongly. In the Figures, like reference numerals refer to like parts, whenever possible.

### DETAILED DESCRIPTION

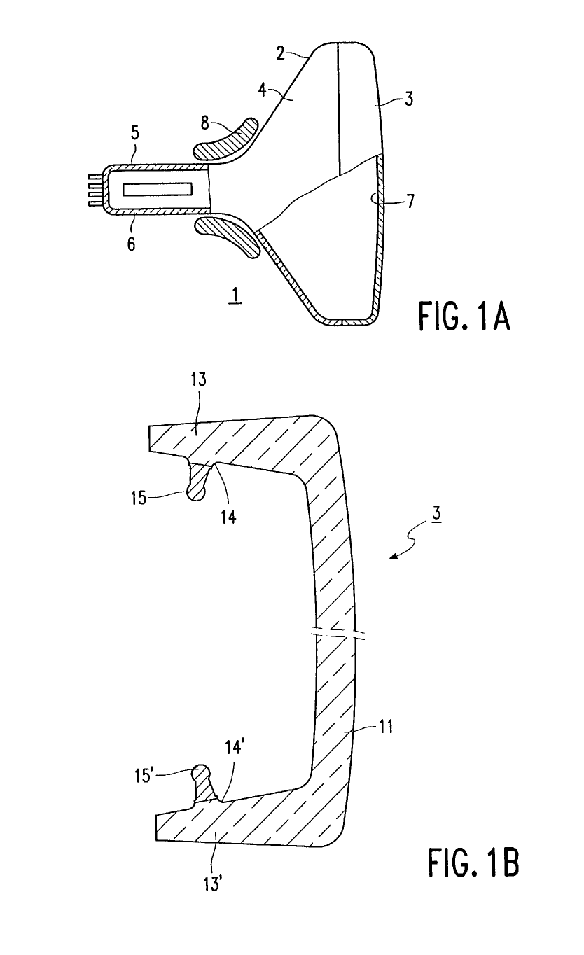

FIG. 1A schematically shows a cut-away view of a display device comprising a cathode ray tube (CRT) 1 having a glass envelope 2 including a display window 3, a cone portion 4 an a neck 5. The neck accommodates an electron gun 6 for generating one or more electron beams. This (these) electron beam(s) is (are) focused on a phosphor layer 7 on the inner surface of the display window 3. The electron beam(s) is (are) deflected across the display window 3 in two mutually perpendicular directions by means of a deflection coil system 8.

FIG. 1B is a cross-sectional view of a display window 3 of the display device 1 shown in FIG. 1A. The display window comprises a curved or substantially flat part 11, a raised edge 13, 13′ by means of which the display window 3 is connected, during assembly, to the cone portion 4 of the air-tight envelope 2 of the display device (see FIG. 1A). This raised edge 13, 13′ generally comprises connecting points 15, 15′ for a so-called shadow mask or selection electrode. For this reason, protrusions 14, 14′ are provided at suitable locations on the inside of the raised edge 13, 13′.

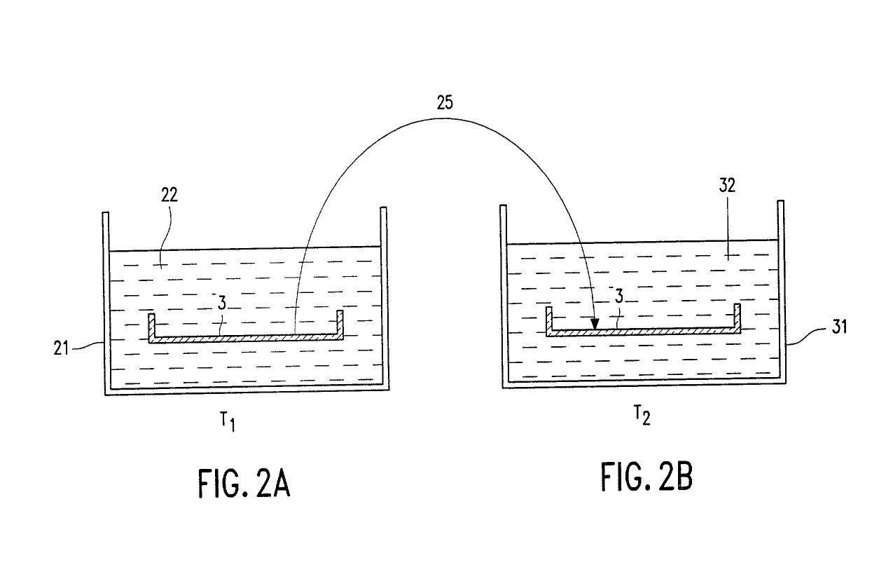

FIGS. 2A and 2B schematically show an example of the method in accordance with the invention. In FIG. 2A, a glass part is warmed up to a first temperature T₁. In the example of FIG. 2A, a display window 3, which forms part of a display device, is immersed in a warming-up vessel 21 containing a fluid 22, for example water, at a temperature T₁. Water has the advantage that it has a high coefficient of thermal conduction (λ≈0.6 W m⁻¹K⁻¹), which leads to a rapid warm up of the glass part. The warm-up in a water bath 21 having a suitable temperature leads to a uniform and homogeneous warm-up of the part. The shape of the part determines the time period t₁ which the part needs to reach a uniform temperature T₁. To render the production of the parts as economical as possible, it is desirable that the residence time in the warming-up vessel 21 is as short as possible.

In the case of a display window 3 having a relatively large surface area relative to the generally small thickness of the glass, the desired warming-up time t₁ is at least 2 minutes and preferably 5 minutes. Alternative ways of warming up the glass part include: irradiating the part using heat-emitting (infrared) radiators, or introducing the glass part into a suitable furnace. The temperature T₁ preferably ranges between 50° C.≦T₁≦100° C., and is, in particular T₁≧65° C., the temperatures being suitable if water is used as the warming-up medium.

In FIG. 2B, a glass part is cooled down to the second temperature T₂. In the example of FIG. 2B, a display window 3, which forms part of a display device, is immersed in a cooling vessel 31 which contains a fluid 32, for example water. The temperature difference between the first and the second temperature preferably ranges from 25°≦T₁−T₂≦85°, and, in particular, T₁−T₂≈50°, which yields a suitable temperature for the cooling vessel if water is used as the cooling medium. Water has the advantage that it has a high coefficient of thermal conduction (λ≈0.6 W m⁻¹ K⁻¹). Moreover, the product of the specific mass (ρ) and the specific heat (cₚ) of water: ρ×cₚ, gives a high value of 4.2×10⁶ J m⁻³ K⁻¹, which results in a desirable, rapid cooling of the glass part. To produce the parts as economically as possible, it is desirable that the residence time in the cooling vessel 31 is as short as possible. For a display window 3 having a relatively large surface area relative to a generally small thickness of the glass, a cooling time t₂ of at least 5 seconds, preferably 10 seconds, is sufficient.

At a given moment, after the glass part has been warmed up at least substantially uniformly to a temperature T₁, it is transferred from the warming up vessel 21 to the cooling vessel 32 having a temperature T₂. In FIG. 2, this transfer operation is symbolically indicated by arrow 25. The transfer of the glass part to a colder environment causes the glass part to be cooled-down suddenly, which is also referred to as quenching. Such a thermoshock treatment gives rise to crack formation in the glass part, which process is initiated at a location where the surface is damaged and/or at locations where relatively large (surface) (tensile) stresses occur in the glass part. Such a treatment of glass parts, in particular of display windows which form part of the air-tight envelope of display devices, enables a good selection to be made at an early stage between usable and non-usable display windows.

### Functional Discussion

In a first embodiment for inducing the thermoshock the face plate or further glass part is warmed up to a first temperature during a first time period, whereafter, commencing while the face plate or further glass part is still warmed-up, the face plate or further glass part is immersed for a second time period in a fluid that when the immersion commences is at a second temperature lower than the first temperature. The fluid may be a gas or, preferable, a liquid.

Since glass is a brittle material, it is sensitive to surface damage and stress-related phenomena. Surface damage is generally difficult to detect by people who are not skilled in the art, and adverse effects of (surface) stresses in glass may not give rise to problems until late in the manufacturing process. In addition, it is not clear how and which surface damage as well as which types of stress in the part contribute substantially to product failure during the further assembly of the air-tight envelope and the display device. Product failure is caused, in particular, by implosion of the envelope of the display device when this is evacuated (for the first time).

In the evacuation process the envelope is also brought to a relatively high temperature (300-400° C.). Such implosions are often initiated by the surface damage or too high a surface stress. When the air-tight envelope of the display device is evacuated for the first time, the display device already is in an advanced stage of assembly, so that an implosion during evacuation and warm-up implies a loss of production.

By subjecting the glass part to a thermo shock test in accordance with the invention, any defects, such as surface defects and stresses at the surface and in the interior of the glass part become visible. This enables the surface damage and stresses to be detected at an early stage, so that such parts can be excluded from the further manufacturing process of the display device. If, for example, in the case of a cathode ray tube, a display window is subjected to the method in accordance with the invention, it can be determined, before the display window is provided with a phosphor pattern and a shadow mask, and before the display window is fritted to the cone portion of the envelope of the display device, whether surface damage on or stresses in the display window will lead to product failure at a later stage of the manufacturing process (for example during evacuation of the envelope). A fluid which can particularly suitably be used for immersing the glass part is the liquid medium water.

Factors involved in the initiation of surface damage of and stresses in glass parts of display devices are, in particular, scratches made in the manufacture of the glass parts and during positioning and handling the parts on a conveyor belt. Another important factor, in particular, for display windows of CRTs having a raised edge via which the display window is connected to the cone portion, and which edge is generally provided with connecting points for connecting a selection electrode or shadow mask, is the degree of compressive stress present in the raised edge of the display window. In general, the method in accordance with the invention does not make a distinction between surface damage and (internal) stresses of the glass part. The resistance to quenching generally is a combination of surface roughness and internal stress of the glass part. The term “quenching” of the glass part is to be taken to mean, in this application, a thermal shock caused by suddenly cooling the part (“thermoshock treatment”), for example by immersing in water.

The thermoshock treatment in accordance with the method of the invention causes cracks to grow at the outside surface of the glass part. These cracks are generally caused by surface damage or they develop in a region where the stress is relatively high. Quenching of the glass part causes the outside surface to be subject to tensile stress, while the material in the interior of the glass part is subject to compressive stress; as a result, cracks do not grow through the glass (i.e., cracks do not propagate in the interior of the glass). This has the advantage that no portions of the part become detached or severed, which would lead to contamination of the set-up for carrying out the method.

One embodiment of the method in accordance with the invention is characterized in that the temperature difference between the first and the second temperature ranges between 25° and 85°, and is preferably approximately 50°.

An important criterion for a good selection test is that the method yields a reliable distinction between usable and non-usable glass parts. A “non-usable” part is to be taken to mean, in this application, that there is a relatively great risk that such a part, which forms part of the air-tight envelope of a display device, will be subject to implosion during evacuation and warm-up of the envelope; conversely, a “usable” part runs a relatively small risk of implosion during evacuation and warm-up. In addition, care must be taken that, in the long run, the method does not adversely affect the glass part, for example, because the treatment causes the quality of the part to deteriorate, which may not give rise to problems until later in the life of the display device.

If the temperature difference between the first and the second temperature is too large, i.e., T₂−T₁>85°, the risk of crack growth as a result of the thermoshock treatment is increased, which leads to a relatively high failure percentage of the glass parts, which is undesirable. In general, the failure probability increases substantially with temperature. If the temperature difference between the first and the second temperature is too small, i.e., T₂−T₁<25°, crack growth occurs only exceptionally, so that the selection treatment has (almost) no power of discernment. Experiments have shown that, between the differences in temperature (25°≦T₂−T₁≦85°), a noticeably different response to the thermoshock treatment occurs. Experiments have further shown that the method in accordance with the invention has a great power of discernment as to the further processability of the part at a temperature difference between the first and the second temperature of approximately 50° (T₂−T₁≈50°).

A suitable value for the first temperature ranges between 50 and 100° C., and is preferably approximately 65° C. In the case of a temperature difference of, preferably, approximately 50° (T₂−T₁≈50°), this results in a value for the second temperature of approximately 15° C. (T₂≈15° C.).

A display window which cracks as a result of the thermo shock test can be added without further treatment (as so-called cullet) to the glass mixture in the melting furnace from which display windows or cone portions are made. If the display window is already provided with a phosphor pattern and/or, during removing the frit connection between the display window and the cone portion, residues of materials (phosphor, cone glass or fritted glass) remain in or on the display window, the composition of the glass mixture in the melting furnace is adversely affected.

One embodiment of the method in accordance with the invention is characterized in that the fluid comprises a liquid having a coefficient of thermal conduction (λ) above 0.4 W m⁻¹ K⁻¹. A liquid having a relatively high coefficient of thermal conduction allows an effective heat transfer of the second temperature to the glass part, if the part originates from an environment having a higher first temperature. The higher the coefficient of thermal conduction, the more effective the thermoshock treatment is. Water is a particularly suitable liquid.

Preferably, the fluid comprises a liquid such that the product of the specific mass (ρ) and the specific heat (cₚ) is greater than ρ×cₚ=2×10⁶ J m⁻³ K⁻¹. Water is a particularly suitable liquid.

By using the method in accordance with the invention, the risk of fracture or implosion of the display device during the manufacture of the display device is reduced, which has a favorable effect on the reduction of the failure percentage and hence on the cost price.

Experiments have shown that the method in accordance with the invention yields a good selection of glass parts. Minor surface damage at arbitrary locations gives rise to crack growth which starts already at the location of the damaged spot at relatively low thermal stress levels. In the case of display windows, it has further been found that, in the absence of surface damage, crack growth generally starts at the location of the raised edge of the display window. Crack growth is often initiated by a relatively low compressive stress in this so-called seal edge. The thermoshock treatment does not distinguish between surface roughness and internal stress, so that the thermoshock treatment generally is indicative of a combined effect of both phenomena.

### Recapitulation

In general, a method has been presented for manufacturing a display device comprising an air-tight envelope and at least a glass part (3) which forms part of the air-tight envelope. As a thermoshock test for parts such as the faceplate (3), the glass part is warmed up, during a first time period, at a first temperature (T₁), whereafter the glass part is immersed, during a second time period, in a fluid at a second temperature (T₂), the second temperature being lower than the first temperature (T₂<T₁). Preferably, 25°≦T₁−T₂≦85°, and, in particular, T₁−T₂≈50°. Preferably, 50° C.≦T₁≦100° C., and, in particular, T₁≈65° C. Preferably, the glass part is a display window or a cone portion of a display window, and the fluid is water.

Thus, the faceplate is first placed in a fluid at a high temperature, whereafter it is quickly transferred to a second fluid (both fluids could be the same, e.g., water) at a substantially lower temperature. The sudden drop in temperature induces a thermoshock effect in the part, which causes flaws such as cracks and stress to become visible. The appearance of such flaws is used to distinguish usable parts from flawed parts. The method makes it possible to remove flawed parts from the production line at an early stage, thus reducing the percentage of displays that do not pass the final inspection or have a reduced life expectancy.

Other embodiments, variations of embodiments, and equivalents, as well as other aspects, objects, and advantages of the invention, will be apparent to those skilled in the art and can be obtained from a study of the drawings, the disclosure, and the appended claims.

We claim:

1. A method of manufacturing a display device having an air-tight envelope, in which a glass face plate and at least one further glass part are joined to form said air-tight envelope that is to be heated and/or evacuated at a later stage of the method of manufacture, comprising:
inducing a thermoshock in the face plate and/or the at least one further glass part prior to joining said glass face plate and the at least one further glass part to form said air-tight envelope;
examining the face plate and/or the at least one further glass part for growth of cracks indicative of defects which could render the air-tight envelope liable to implosion during heating and/or evacuation;
choosing between selecting and non-selecting said face plate and/or the at least one further glass part for use as part of said air-tight envelope depending on whether said growth of cracks has been found;
using said face plate and said at least one further glass part as part of said air-tight envelope if said growth of cracks was not found; and
performing the heating and/or evacuation of said airtight envelope after said air-tight envelope has been constructed using said face plate and said at least one further glass part.

2. The method of claim 1, wherein for inducing the thermo shock, the face plate or further glass part is warmed up to a first temperature during a first time period and then, commencing while said face plate or further glass part is still warmed up, said face plate or further glass part is immersed for a second time period in a fluid that when said immersion commences is at a second temperature lower than the first temperature.

3. The method of claim 2, wherein the temperature difference between the first and the second temperature ranges between 25° and 85° C.

4. The method of claim 2, wherein the first temperature ranges between 50 and 100° C.

5. The method of claim 2, wherein the fluid comprises a liquid having a coefficient of thermal conduction (λ) above 0.4 W m⁻¹ K⁻¹.

6. The method of claim 2, wherein the fluid comprises a liquid such that the product of the specific mass (ρ) and the specific heat (cₚ) is greater than 2×10⁶ J m⁻³ K⁻¹.

7. The method of claim 2, wherein a first time period lasts at least 2 minutes and preferably 5 minutes, and the second time period lasts at least 5 seconds.

8. The method of claim 2, wherein, during the first time period, the face plate or further glass part is situated in water at the first temperature.
